(19) United States
(12) Patent Application Publication
(10) Pub. No.: US 2007/0299555 A1
(43) Pub. Date: Dec. 27, 2007

(54) Products and Processes for Managing a Vending Machine Transaction

(76) Inventors: Jay S. Walker, Ridgefield, CT (US); Paul T. Breitenbach, Wilton, CT (US); Daniel E. Tedesco, Shelton, CT (US); James A. Jorasch, New York, NY (US); Dean P. Alderucci, Westport, CT (US)

Correspondence Address: WALKER DIGITAL MANAGEMENT, LLC, 2 HIGH RIDGE PARK, STAMFORD, CT, 06905, US

(21) Appl. No.: 11/538,293

(22) PCT Filed: Apr. 5, 2005
(86) PCT No.: PCT/US05/11699

§ 371 Date: Oct. 3, 2006

Related U.S. Application Data
(60) Provisional application No. 60/559,633, filed on Apr. 5, 2004.

(30) Foreign Application Priority Data
Apr. 5, 2005 (US) US2005/011699

(51) Int. Cl. G06F 17/00

(52) U.S. Cl. 700/231

(57) ABSTRACT

Accordingly to an embodiment, a method includes providing an offer to receive a benefit in lieu of receiving change that is due from a transaction with a vending machine.

This application claims priority to International Application No. PCT/US2005/011699 entitled “MANAGING A VENDING MACHINE TRANSACTION”, filed Apr. 5, 2005 which published as WO 2005/097639 and also claims priority to U.S. Provisional Patent Application Serial Number 60/559,633, entitled “APPARATUS, SYSTEM AND METHOD FOR MANAGING VENDING MACHINE TRANSACTIONS”, filed Apr. 5, 2004

Each of the above-referenced applications is incorporated by reference herein in its entirety.

### BRIEF DESCRIPTION OF THE DRAWINGS

FIG. 1 illustrates an embodiment of control software.

FIG. 2 illustrates an embodiment of a ticket that provides alternate value offers.

### DETAILED DESCRIPTION

Disclosed Examples Are Not Limiting

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. Those skilled in the art will recognize that the disclosed invention(s) may be practiced with various modifications and alterations. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Neither the Title (set forth at the beginning of the first page of this patent application) nor the Abstract (set forth at the end of this patent application) is to be taken as limiting in any way as the scope of the disclosed inventions).

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention(s).

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Terms

The terms “an embodiment”, “embodiment”, “embodiments”, “the embodiment”, “the embodiments”, “one or more embodiments”, “some embodiments”, “one embodiment” and the like mean “one or more (but not all) embodiments of the disclosed invention(s)”, unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The terms “plurality” mean “two or more”, unless expressly specified otherwise.

The phrase “at least one of” means “one or more”, unless expressly specified otherwise.

Each process/method includes one or more steps, and therefore a reference to a “step” of a method has an inherent antecedent basis.

When an ordinal number (such as “first”, “second”, “third” and so on) is used as an adjective before a term, that ordinal number is (unless expressly specified otherwise) used merely to indicate a particular element, such as to distinguish it from another element that likewise is described by the same term or by a similar term. For example a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments need not include the device itself.

Computing

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of known media in a number of well-known manners. In some embodiments, hard-wired circuitry or custom hardware may be used in place of, or in combination with, software instructions for implementation of the processes of the present invention. Thus, embodiments are not limited to any specific combination of hardware and software

The term “computer-readable medium” refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PRO M, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed.

Products and processes are disclosed for providing an offer to receive a benefit in lieu of receiving change that is due from a transaction with a vending machine. In an embodiment, products and processes are disclosed for providing vending machine customers with “alternate value offers” in exchange for the change due from a transaction with a vending machine.

In an embodiment, the value of the benefit is greater than the value of the change due (typically from the perspective of the customer).

The benefit to be received in lieu of change may be in any of various form, such as (i) discounts (e.g., on prices of products sold via a vending machine), (ii) credits (e.g., credits applicable to purchases at a vending machine), (iii) specific products (e.g., products dispensed via a vending machine without further consideration), (iv) the ability to select and acquire one or more products from a class of products, either at a normal price, at a discount or without further consideration (e.g. any soda; any item indicated by a flashing red Light Emitting Diode (LED)), (v) entries in games of skill or games of chance, such as entries in one or more lottery drawings, (vi) the ability to download digital content (e.g. MP3 music files, computer files, ring tones for cellular telephones) from a remote computer or elsewhere, and/or (vii) a modification of another benefit or of a right of the customer.

An offer may be provided in various manners. Such offers may be printed (e.g., on a paper substrate), displayed (e.g., on a monitor), provided via audio (e.g., through a speaker) and/or transmitted via an information network (e.g., via email, downloaded to a cellular telephone or PDA).

In some embodiments, a vending machine is configured to provide customers with alternate value offers printed on paper tickets, which enable customers to receive either (1) change due from a first transaction, or (2) a benefit.

For example, a customer who purchases a first product priced at $0.65 from a vending machine by depositing $1.00 may be entitled to $0.35 change (i.e. $1.00−$0.65=$0.35). Rather than immediately dispensing the $0.35 change through a change dispensing apparatus, the vending machine may print and output a paper ticket providing the customer with the ability to either (1) enter a first code (indicated on the ticket) using the vending machine's keypad to receive $0.35 (e.g., immediately) from the machine's coin dispensing apparatus, or (2) enter a second code to receive a $0.45 credit towards the purchase of a second product (e.g., at a time of the customer's choosing).

Various embodiments confer different advantages. For example, the ability to provide offers for a benefit in lieu of change can permit vending machines to retain deposited change (since less change is dispensed when such offers are accepted by customers). When alternate value offers are accepted, the increase in retained change can increase vending machine revenue (either temporarily or permanently, as described below). Further, the increase in retained change can increase the vending machine's ability to provide one or more future customers with correct change (e.g., during a sales period prior to a restock date as coin reserves are thereby increased).

In various embodiments, the benefit of an offer can be received almost immediately after acceptance (e.g., during the same vending machine transaction), in the future (e.g., during a subsequent vending machine transaction), and/or for a limited time (e.g., redemption is permitted only during certain times, prior to a certain date).

Further, in various embodiments, alternate value offers may provide customers with the ability to receive such benefits at one or more machines and/or at one or more locations. For example, alternate value offers may provide customers with the ability to receive benefits from a vending machine that issued the offer, from a separate machine (e.g. a beverage vending machine located next to a snack vending machine which provided the offer), and/or from a computer (e.g. a web server which permits the downloading of digital content upon receipt of a valid alphanumeric code).

In some embodiments, whether to provide an offer and/or the content of the offer can depend on various factors. For example, whether to provide an offer and/or the content of the offer can depend on the vending machine's current coin or anticipated inventory (e.g., whether the coin inventory is below a threshold), the vending machine's current or anticipated product inventory, the offer's likelihood of acceptance and other conditions or factors.

Finally, in some embodiments, the acceptance and/or redemption of an offer may be facilitated through the use of codes which the customer may enter, e.g., into a vending machine. For example, a particular alphanumeric code may be associated (in an known manner) with a command to provide various benefits, such as dispense an item or issue credit redeemable for at least one item that is dispensed by vending machine.

### Definitions Used Herein

Actual Item Velocity—The actual rate at which a given product is sold by a vending machine during a sales period. The actual rate may be expressed in various forms, including units sold per time, sales revenue per time, and profit per time.

Alternate Value Offer, Promotional Offer—An offer provided to a customer of a vending machine which enables the customer to receive either (1) change due from a first transaction, or (2) a benefit. Alternate value offers may be provided to customers through an output device of a vending machine, such as a printer (e.g. offers are printed on paper tickets) or Liquid Crystal Display (LCD) screen. Alternate value offers may be provided to customers through an output device of a separate computer or device, such as a personal computer, a Personal Digital Assistant (PDA), or a cellular telephone.

Benefit—A payment or other advantage. Some examples of benefits include discounts on products, credits applicable to products, specific products, the ability to receive one or more selected products from a class of products (e.g. any soda; any item indicated by a flashing red Light Emitting Diode).

Coin Conservation—The practice of managing the working capital stored in a vending machine, such as by managing an inventory of coins or other currency, so as to reserve or acquire a minimum amount. This minimum amount can be used, e.g., to provide customers with change when appropriate. In some embodiments, a vending machine can engage in coin conservation efforts by configuring and outputting one or more alternate value offers to a customer. For example, where a forecast based on current sales patterns indicates that an insufficient number of coins remain in the machine to make correct change for every anticipated transaction throughout the remainder of a fill period, a vending machine control system may engage in coin conservation by executing alternate value offers (e.g. where customers are offered discounts on additional products in lieu of their change due).

Coin Inventory, Coin Reserves, Working Capital—The supply of currency (e.g., coins) available to a vending machine that can be used to provide a customer with appropriate change pursuant to one or more transactions.

Fill Period, Sales Period—The period of time between restock dates.

Full Price, Retail Price—The price normally charged for the purchase of a given product. Typically, alternate value offers present customers with the opportunity to purchase items at less than full price.

Ideal Product Velocity, Target Product Velocity, Target Velocity—The desired rate at which a given product should be sold by a vending machine during a period of time, such as a sales period. Thus, in some embodiments, an ideal velocity may be set or calculated for each product indicating the rate at which products must be sold in order to deplete the inventory to a certain level by the end of a given sales period (i.e. by the restock time). For example, an ideal product velocity may be calculated (e.g., by a vending machine control system) after an operator inputs a restock date and a desired remaining inventory for the date (e.g. an operator may wish to have only 1 of each item remaining at the restock date so that the machine sells as many items as possible without completely selling out and thereby disappointing customers). Thus, if an operator (a) stocks 50 units of Soda A, (b) inputs a restock date fourteen days away, and (c) indicates that only one unit of Soda A should remain at the restock date, the control system may divide 49 by 14 to conclude that, on average, 3.5 units must be sold per day within the sales period in order to realize the ideal product velocity. As discussed herein, a vending machine control system may periodically, substantially continuously, or otherwise determine whether or not actual item velocity is at least equal to the ideal item velocity, and if not, may institute promotions (e.g. alternate value offers) as discussed herein. An ideal product velocity may be further set so that if such a velocity is reached, the increase in volume will sufficiently offset any discounts afforded to customers through promotions. The actual rate at which a given product should be sold may be expressed in various forms, including units sold per time, sales revenue per time, and profit per time.

Minimum Selling Price—The lowest price at which an item may be sold. The minimum selling price may not necessarily reflect the cost of the product to the operator of a vending machine. Thus, the minimum selling price may include an acceptable profit margin. Conversely, the minimum selling price may be set less than the cost of a product to the operator of a vending machine.

Operator—The owner (or employee or agent thereof) of a vending machine.

Product, Item—A good or service provided at a vending machine. Examples of goods provided by vending machines include beverages (e.g. cans of soda) and snacks (e.g. candy bars). In many types of beverage and snack vending machines, several units of the same product are linearly arranged in a row (or column) and individually dispensed upon command. The same product may be stocked in more than one row. Similarly, more than one product may be stocked in a single row. Examples of services sold by vending machines include car washes, photography services and access to digital content (e.g. permitting the downloading of MP3 files to a handheld device such as an iPod™; permitting the downloading of ring tones to a cellular telephone).

Profit Inventory Management (PIM)—The practice of managing the sale of products so as to increase a vending machine's profitability during a period of time, such as a sales period. In some embodiments, a vending machine is programmed to evaluate sales data in light of stored rules indicative of a profit goal. For example, stored rules may indicate an ideal product velocity that would tend to increase the machine's profitability. The machine may determine that, based on current sales data, the ideal product velocity (for a given product or group of products) will not be achieved based on current promotions, prices, or other sales parameters. In response, the vending machine may execute alternate value offers with the goal of achieving the ideal product velocity (for a given product or group of products).

Restock Date, Restock Time—The time and/or date that a vending machine is scheduled to be restocked (with products and/or working capital) by an operator of a vending machine.

Target Profit, Ideal Profit—In some embodiments, the profit goal set by an operator of a vending machine. A Target Profit may be applied to a vending machine, group of vending machines, a product, a group of products or to all products. A Target Profit may also be applied to more than one vending machines. The target profit may be expressed in various forms, including dollars per time, dollars per unit sold, and aggregate dollars by a point in time.

Ticket, Change Ticket Printed Ticket, Voucher—An object (e.g., formed of paper or plastic) that is output from a vending machine for the purpose of communicating an alternate value offer. Thus, in some embodiments, a vending machine control system may determine an alternate product offer and instruct a peripheral device such as an onboard thermal printer to print the offer on a paper ticket and output the ticket to a customer. The ticket may also serve as a receipt for the transaction.

I. Vending Machine Apparatus

Introduction

Generally, a vending machine in accordance with the present invention can include a device configured to manage sales transactions with customers by, among other things, receiving payment from customers, controlling the pricing and/or distribution of goods and/or controlling entitlements to services.

Machine Casing/Cabinetry

In some embodiments, suitable machine cabinetry may be constructed from any suitable material, including but not limited to any combination of (1) commercial grade steel (e.g. for exterior panels and internal shelving), (2) transparent materials such as glass or Plexiglas (e.g. for item display windows), (3) rubber (e.g. for waterproofing insulation), (4) plastic, and/or (5) aluminum.

Many commercially available machine casings can be adapted to work in accordance with the present invention. For example, in snack machine embodiments, a suitable machine casing may comprise the 129 SnackShop manufactured by Automatic Products international, Ltd. of Saint Paul, Minn., which stands at 72″ (1829 mm), has a width of 38⅞″ (988 mm), and a depth of 35″ (889 mm). Other suitable snack machine casings include the A La Carte® machine from Automatic Products, and the GPL SnackVendor model # 159 from Crane Merchandising Systems/Crane Co. of Stamford, Conn.

In beverage machine embodiments, machine casings commercially available from Dixie Narco, Inc. of Williston, S.C. may be employed. Beverage machine casings may comprise a “cooler” or “glass front” style front panel, featuring a transparent front panel (e.g. glass) enabling customers to see inventory for sale. Alternatively, beverage machine casings may comprise a “bubble front” style front panel, featuring a decorative front panel, typically used to advertise a logo of a product manufacturer commercially interested in the vending machine's operation.

Other embodiments are contemplated as well, including combination snack and beverage vending machine embodiments, such as those available from Crain Co. Further details concerning the suitability of machine casing/cabinetry are well known in the art, and need not be described in further detail herein.

Inventory Storage and Dispensing Mechanisms

Inventory storage and distribution functions of a vending machine configured in accordance with a snack machine embodiment of the present invention may include one or more conventional components, including: (i) a drive motor, (ii) metal shelves, (iii) a product delivery system (e.g. a chute, product tray, product tray door, etc.), (iv) dual spiral (i.e. double helix) item dispensing rods, (v) convertible (i.e. extendable) shelves, and/or (vi) a refrigeration unit. In embodiments using the casing of the model 129 SnackShop manufactured by Automatic Products, 3 removable shelves may be employed, together providing for 30 product rows and an inventory capacity of between 185 to 522 commonly vended snack products.

Inventory storage and distribution functions of a vending machine configured in accordance with a beverage machine embodiment of the present invention may include one or more conventional components, including: (i) metal and/or plastic shelving, (ii) item dispensing actuators/motors, (iii) product delivery chutes, and/or (iv) a refrigeration unit.

Further details concerning vending machine inventory storage and dispensing mechanisms are well known in the art, and need not be described in further detail herein.

Payment Processing Mechanisms

The vending machine may also include one or more mechanisms for receiving payment and dispensing change, including a coin acceptor, a bill validator, a card reader (e.g. a magnetic stripe reader) and a change dispenser. Such mechanisms may be integrated, combined, or separate.

In a manner known in the art, a magnetic stripe card reader may read data on the magnetic stripe of a credit or debit card, and it may cooperate with known credit card processing equipment to validate card-based purchases through a conventional transaction authorization network. Suitable card-based transaction processing systems and methods are available from USA Technologies, Inc.

The coin acceptor, bill validator and change dispenser may communicate with a currency storage apparatus (e.g., a “hopper”) and may comprise conventional devices such as models AE-2400, MC5000, TRC200 by Mars, Inc. of West Chester, Pa., or CoinCo model 9300-L. The coin acceptor and bill validator may receive and validate currency that is stored by the currency storage apparatus. The change dispenser activates the return of coinage from the currency storage apparatus to the customer where appropriate (e.g. where a customer deposits more currency than is required for a given transaction; where a customer rejects an alternate value offer and/or affirmatively requests a change amount). Such apparatus may feature Multidrop Bus (MDB) and/or Micromech peripheral capabilities, as is known in the art.

In some embodiments, the coin acceptor, currency storage apparatus and/or change dispenser may together comprise one unit (such as the MEI CASHFLOW series 7000 from Mars, Inc.), or may otherwise be configured to work in conjunction, so that coins received from customers may subsequently be used to provide customers with change. Such embodiments may be desirable in those embodiments, detailed herein, which function to employ alternate value offers until coin reserves are replenished to a threshold level. For example, in an embodiment, a vending machine may output one or more alternate value offers to customers when change reserves have depleted below a threshold level, and cease outputting such offers once change reserves are replenished by virtue of coin-based sales and/or the success of alternate value offers (which encourage customers forfeit or defer collection of change due in exchange for a benefit).

In some embodiments, the MEI CASHFLOW series 7000 may be desirable as such apparatus may calculate a machine's anticipated change requirements based on historic transaction data. Further, the currency handling apparatus described in WO 98/58355, published Dec. 23, 1998, entitled “Currency Handling Apparatus” (the entirety of which is incorporated by reference herein), may be desirable, as such an apparatus similarly calculates an estimated amount of currency necessary to meet a predicted future distribution of currency. The MEI CASHFLOW series 7000 and the currency handling apparatus of WO 98/58355 merely describe apparatus for calculating a desirable amount of stored currency; operators employing such prior art mechanisms may, at best, use such calculations to determine a quantity of currency to stock. However, in embodiments of the present invention that feature such coin mechanisms as the MEI CASHFLOW series 7000 and that described in WO 98/58355, such calculations may be used, as described herein, to set the threshold levels which determine when one or more alternate value offers should be output to customers.

In another embodiment, a vending machine in accordance with the present invention may be configured to receive payment authorization and/or product selection commands through a wireless device communication network, directly or indirectly, from a customer's wireless device (e.g. a cellular telephone; a PDA). In such an embodiment, a payment processing mechanism may comprise a cellular transceiver operatively connected to a processor, as described herein. Systems and methods allowing for the selection of and payment for vending machine articles through cellular telephones are provided by USA Technologies, Inc., of Wayne, Pa. Further, in such an embodiment, a cellular telephone may serve as an input/output device, as described herein.

Further details concerning vending machine payment processing mechanisms are well known in the art, and need not be described in further detail herein.

Input/Output Devices

In accordance with the presenting invention, a vending machine may include an input device for receiving input from (i) a customer indicating a product and/or offer selection, and/or (ii) an operator (or agent thereof) during stocking or maintenance of the vending machine. Also, a vending machine may include one or more output devices for outputting product or offer information to a customer or operator.

Many combinations of input and output devices may be employed in accordance with the present invention. In some embodiments, a vending machine may include more than one input device. For example, a vending machine may include an exterior input device for receiving customer input and an interior input device for receiving operator input. In some embodiments, however, the input device provides the dual functionality of receiving input data from both operators and customers. Likewise, a vending machine may comprise more than one output device (e.g. an LCD screen and several LEDs, as described herein). However, in some embodiments, such as those which feature touch screens (described herein), input and output functionality may be provided by a single device.

Many types of input devices are contemplated. Thus, an input device may comprise one or more of (1) a set of alpha-numeric keys for providing input to the vending machine, such as the programmable Master Menu® Keypad, (2) a selector dial, (3) a set of buttons associated with a respective set of item dispensers, (4) a motion sensor, (5) a barcode reader, (6) a magnetic stripe card reader, (7) a voice recognition module and/or microphone, (8) a Dual-Tone Multi-Frequency (DTMF) receiver/decoder, (9) a wireless device (e.g. a cellular telephone or wireless Personal Digital Assistant), (10) a biometric sensor such as a finger print reader; and/or (11) any other conventional input device commonly employed by a vending machine designer.

Likewise, many types of output devices are contemplated. For example, an output device may comprise an LCD display. Alternatively or additionally, an output device may also comprise one or more LED displays (e.g. several alphanumeric multi-color or single color LED displays on the shelves of a vending machine associated proximately with each row of product inventory).

In one embodiment, an LED display screen is mounted atop the vending machine (via bolts or other mounting hardware) and is used to communicate alternate value offers and other messages (e.g. product advertisements) to prospective customers. A suitable LED display screen for such an embodiment may be housed in an aluminum case having a length of 27.5″, a height of 4.25″, and a depth of 1.75″. Such a display screen may have a display area capable of showing 13 alphanumeric and/or graphical characters. Further, such an LED display screen may comprise a serial computer interface, such as an RJ45/RS232 connector, for communicating with a processor, as described herein. Further still, such an LED display may be capable of outputting text and graphics in several colors (e.g. red, yellow, green, black) regarding current and upcoming promotions.

Further, in some embodiments, an output device comprises a printer. In one embodiment, a printer is configured to print on card stock paper (e.g. 0.06 mm to 0.15 mm thickness), such as the EPSON EU-T400 Series Kiosk Printer. In another embodiment, a printer is capable of thermal line printing of various alphanumeric and graphical symbols in various font sizes (e.g. ranging from 9 to 24 point) on various types of paper. Printers with such capability include the NP-345 by Nippon Primex, and the PSA-11 by Seiko Instruments, both of which accept folded, perforated thermal paper. Other suitable printers may be capable of stocking thermal roll paper that is separated with cutters, such as the HECON TPM 80 or TPM 100, the KF-6580 from Bematech International and the A226 and A223 printers from Axiohm. Additionally, such printers may communicate with a processor (described herein) via an RS232/IEEE 12834 and/or bi-directional parallel connection. Further, such a printer may further comprise a 4 KB data buffer.

Further still, an output device may comprise a magnetic strip card dispenser and/or reader/writer. Thus, in some embodiments, a vending machine may be configured to output, receive and/or record onto magnetic stripe cards that contain alternate value offer codes recorded thereon. Such cards may subsequently be presented by customers and accepted by a card reader so that alternate value offers may be accepted, modified and/or redeemed.

Additionally, in some embodiments, an output device comprises an audio module, such as an audio speaker, that outputs information to customers audibly. Speakers may comprise conventional acoustic speakers and/or modern hypersonic speakers.

As stated, in some embodiments, a touch-sensitive screen may be employed to perform both input and output functions. Suitable, commercially available touch screens for use in accordance with the present invention are manufactured by Elo TouchSystems, Inc., of Fremont, Calif., such as Elo's AccuTouch series touch screens. Such touch screens may comprise: (i) a first (e.g. outer-most) hard-surface screen layer coated with an anti-glare finish, (ii) a second screen layer coated with a transparent-conductive coating, (iii) a third screen layer comprising a glass substrate with a uniform-conductive coating. Further, such touch screens may be configured to detect input within a determined positional accuracy, such as a standard deviation of error less than ±0.080-inch (2 mm). The sensitivity resolution of such touch screens may be more than 100,000 touchpoints/in² (15,500 touchpoints/cm²) for a 13-inch touch screen. For such touch screens, the touch activation force required to trigger an input signal to the processor (described herein) via the touch screen is typically 2 to 4 ounces (57 to 113 g). Additionally, touch screens for use in accordance with the present invention may be resistant to environmental stressors such as water, humidity, chemicals, electrostatic energy, and the like. These and other operational details of touch screens (e.g. drive current, signal current, capacitance, open circuit resistance, closed circuit resistance, etc.) are well known in the art and need not be described further herein.

Logic/Control/Processing Apparatus

In some embodiments, the components of the vending machine, including the input device, output device, coin acceptor, bill validator, card (e.g. magnetic stripe) reader, change dispenser, currency storage apparatus, and product dispensing mechanism(s) (collectively, the “peripherals”), communicate with, and are controlled by, a control system or processor, such as one based on the Intel® Pentium® or Centrino™ series processor. The processor may be in communication with a memory and a communications port (e.g., for communicating with one or more other computers or vending machines). The memory may comprise an appropriate combination of magnetic, optical and/or semiconductor memory, and may include, for example, Random Access Memory (RAM), Read-Only Memory (ROM), a compact disc and/or a hard disk. The memory may comprise or include any type of computer-readable medium. The processor and the memory may each be, for example; (i) located entirely within a single computer or other device; or (ii) connected to each other by a remote communication medium, such as a serial port cable, telephone line or radio frequency transceiver.

A memory may store a program for controlling a processor. The processor performs instructions of the program, and thereby operates in accordance with the present invention, and particularly in accordance with the processes described in detail herein. The program may be stored in a compressed, uncompiled and/or encrypted format. The program furthermore includes program elements that may be necessary, such as an operating system, a database management system and “device drivers” for allowing the processor to interface with and instruct the peripherals. Appropriate program elements are known to those skilled in the art, and need not be described in detail herein.

The term “computer-readable medium” as used herein refers to any medium that participates in providing instructions to a processor for execution. Such a medium may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Transmission media include coaxial cables, copper wire and fiber optics, including the wires that comprise a system bus coupled to the processor. Transmission media may carry acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. Various forms of computer readable media may be involved in carrying one or more sequences of one or more instructions to a processor for execution.

According to an embodiment of the present invention, the instructions of the program may be read into a main memory from another computer-readable medium, such as from a ROM. The execution of sequences of the instructions in a program causes the processor to perform the process steps described herein. In alternate embodiments, hard-wired circuitry may be used in place of, or in combination with, software instructions for implementation of the processes of the present invention. Thus, embodiments of the present invention are not limited to any specific combination of hardware and software.

The memory also may store one or more databases. Some or all of the data stored in each database is described herein. The described data represents exemplary information only; those skilled in the art will understand that the number, content, and form of the data can be different from that which is described herein without departing from the spirit and scope of the invention. Further, despite any description of the databases as tabular, relational databases, an object-based model could be used to store and manipulate the data types of the present invention and likewise, object methods or behaviors can be used to implement the processes of the present invention.

Thus, the machine's processing apparatus, in conjunction with the peripherals (e.g. through RS232 connections and/or other suitable connections), manages interactions with the user in accordance with stored business logic, described herein.

Retrofitting Conventional Vending Machines with a Separate Device

In one embodiment, one or more of the processor, the input device(s), RAM, ROM, output device(s) and a data storage device may be included, wholly or partially, in a separate device, such as the e-Port™ by USA Technologies Inc., that is in communication with a vending machine. The separate device may also be in communication with a network such as the Internet.

The e-Port™ is a credit and smart card-accepting unit that controls access to office and MDB vending equipment, and serves as a point of purchase credit card transaction device. The e-Port™ includes an LCD that allows for the display of color graphics, and a touch sensitive input device (touch screen) that allows users to input data to the device. The display may be used to prompt users interactively with, e.g., alternate value offers and information about the status of a transaction.

The separate device may include a printer, as described herein, for printing and outputting alternate value offers and other information to customers.

The separate device may alternatively be a programmed computer running appropriate software for performing the necessary functions described herein. The separate device may be operable to receive input from customers, receive payment from customers, exchange information with a remotely located server and/or output (e.g. print and dispense) alternate value offers to customers. The separate device may be operable to instruct the vending machine that appropriate payment has been received (e.g., via a credit card read by the separate device) and/or that a particular product or products should be dispensed by the vending machine. Further, a separate device may be operable to instruct the vending machine to execute alternate value offer promotions.

Thus, a separate device may be operatively connected to a vending machine to perform the inventive processes described herein. In this manner, conventional vending machines may be retrofitted with such separate devices so as to perform the inventive processes described herein.

Network Embodiments

The present invention can be configured to work in a network environment including a computer that is in communication, via a communications network, with one or more vending machines. The computer may communicate with the vending machines directly or indirectly, via a wired or wireless medium such as the Internet, LAN, WAN or Ethernet, Token Ring, or via any appropriate communications means or combination of communications means. Each of the vending machines may comprise computers, such as those based on the Intel® Pentium® or Centrino™ processor, that are adapted to communicate with the computer. Any number and type of machines may be in communication with the computer.

Communication between the vending machines and the computer, and among the vending machines, may be direct or indirect, such as over the Internet through a Web site maintained by the computer on a remote server or over an on-line data network including commercial on-line service providers, bulletin board systems and the like. In yet other embodiments, the vending machines may communicate with one another and/or the computer over RF, cable TV, satellite links and the like.

Some, but not all, possible communication networks that may comprise the network or be otherwise part of the system include: a local area network (LAN), a wide area network (WAN), the Internet, a telephone line, a cable line, a radio channel, an optical communications line, and a satellite communications link. Possible communications protocols that may be part of the system include: Ethernet (or IEEE 802.3), SAP, ATP, Bluetooth™, and TCP/IP. Communication may be encrypted to ensure privacy and prevent fraud in any of a variety of ways well known in the art.

Those skilled in the art will understand that vending machines and/or computers in communication with each other need not be continually transmitting to each other. On the contrary, such vending machines and/or computers need only transmit to each other as necessary, and may actually refrain from exchanging data most of the time. For example, a vending machine in communication with another machine via the Internet may not transmit data to the other machine for weeks at a time.

In an embodiment, a server computer may not be necessary and/or preferred. For example, the present invention may, in one or more embodiments, be practiced on a stand-alone vending machine and/or a vending machine in communication only with one or more other vending machines. In such an embodiment, any functions described as performed by the server computer or data described as stored on the server computer may instead be performed by or stored on one or more vending machines.

In other embodiments, a vending machine may be in communication with a remote computer, such as a server, that provides the vending machine with and/or receives from the vending machine, e.g., all or some of the data described herein. Thus, in certain embodiments, the server may comprise certain elements or portions of certain elements such as a data storage device/memory.

In one embodiment, the remote computer could be accessible, directly or indirectly, via a second computer (communicating over the Internet or other network) by a customer or operator. Accordingly, a customer or operator of the second computer could communicate with the remote computer via a Web browser. The second computer could, e.g., receive from the remote computer messages described herein as being output by the vending machine, and/or transmit to the remote computer input described herein as being provided to the vending machine. Similarly, various data described herein as received through an input device of a vending machine may be received through a Web browser communicating with a remote server, which in turn communicates with the vending machine. Thus, an operator of the vending machine may have remote polling and reporting capabilities, may be able to transmit new business rules to the vending machine, and the like.

II. Processes

Software

In one embodiment, a software-based control system executes instructions for managing the operation of the vending machine, and in particular in accordance with the inventive functionality described herein. Such vending machine operations include, but are not limited to: (1) item pricing (e.g. displaying prices via an LED, changing such prices where appropriate, etc.), (2) processing vending transactions by (i) receiving customer selections via an input device, (ii) processing payment via a payment processing mechanism, and (iii) actuating corresponding item dispensing mechanisms, (3) identifying alternate value offers, (4) outputting alternate value offers to customers via output devices (including display of graphics/content on LCD and LED displays; printing of offers on cardstock and dispensing such printed material), and (5) recording transaction information (inventory levels, acceptance rates for alternate value offers, etc.).

In some embodiments, machine peripherals (e.g. machine hardware, including mechanical hardware such as input devices, output devices, inventory dispensing mechanisms, and payment processing mechanisms including coin acceptors, bill validators, card readers, change dispensers, etc.) will be controlled by the software-based control system through a standard RS-232 serial interface. In such embodiments, embedded APIs (Application Program Interfaces)/devices may be used to enable the software to actuate/control vending machine peripherals via RS-232 connectivity. Such vending machine peripherals may be operatively connected to the control system directly or indirectly, in any manner that is practicable.

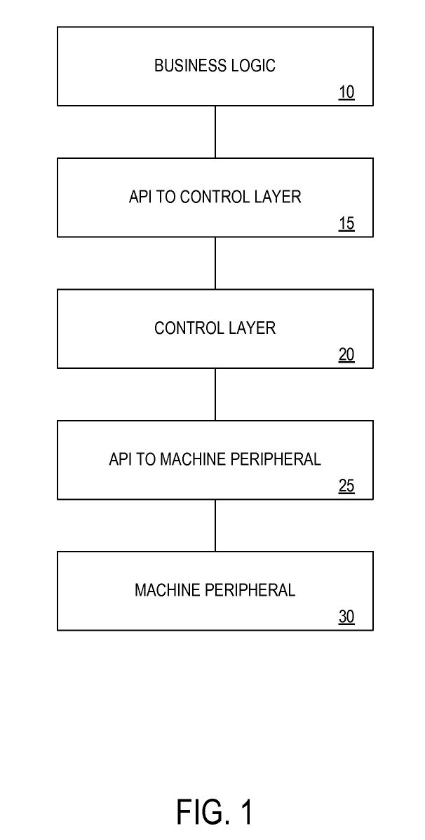

As illustrated by FIG. 1, in one embodiment the control software that directs the control system can be divided into three abstract components. Such division may provide a clear partition of tasks, which may be desirable so that any future modification and new programming of one component can be applied without disrupting other components. Such division also permits certain details of a component to be safely ignored by other components. Turning to FIG. 1, the three abstract components are illustrated, including a Business Logic component 10, a Control Layer component 20, and an exemplary Machine Peripheral component 30. As stated earlier, more machine peripherals may be employed. The Business Logic component 10 is connected to Control Layer component 20 via API 15; Control Layer component 20 is connected to Machine Peripheral component 30 via API 25.

Turning to FIG. 1, in one embodiment the Business Logic component 10 visually represents the portion of the software that executes alternate value offers, as discussed herein. Such a component may access one or more databases (e.g. an alternate value offer rules database, product database, a coin reserve database, and/or a transaction history database) to perform such functions. The Control Layer component 20 visually represents the portion of the software which interfaces with at least one Machine Peripheral component 30, and thereby transmits commands to perform such functions as: (i) outputting alternate value offer information via an output device (i.e. a Machine Peripheral component 30), (ii) dispensing products via a product dispensing mechanism (i.e. a Machine Peripheral component 30), and/or (iii) dispensing change due to a customer via a payment processing mechanism, which may include a change dispenser and a currency storage apparatus (i.e. several Machine Peripheral components 30). As stated, the Machine Peripheral component 30 generally represents machine hardware, including mechanical hardware such as input devices, output devices, inventory dispensing mechanisms, and payment processing mechanisms including coin acceptors, bill validators, card readers, change dispensers, etc.

Notwithstanding the embodiment of FIG. 1, those of ordinary skill in the art will readily recognize that the control software may be abstractly represented in many, nonexclusive manners. Further, software may be developed and/or represented according to many well-known paradigms besides a “layered” paradigm.

Various Process Steps

According to some embodiments, a process designed to manage offers (e.g. identify, output and/or process alternate value offers) is stored in the memory of a vending machine and is executed by the control system (e.g. the processor, RAM, ROM, etc.) utilizing the vending machine's peripheral devices (e.g. the printer, the keypad). Although the process steps may be described as being performed by, or from the perspective of, the vending machine control system, such descriptions are merely illustrative of one embodiment. As discussed above, the embodiments described herein may be performed in whole or part on one or more vending machines, computers, and/or devices.

Exemplary process steps of an embodiment comprising eight steps (steps 100 through 800) are described below. This specific recitation of eight steps is not limiting on the scope of the invention. The present invention includes several other embodiments in which the same or similar steps as those steps described below are arranged in other orders and with fewer or more steps than eight. Moreover, none of the eight steps need be considered essential to the present invention; they are described merely to illustrate various embodiments that happen to include such steps, and variations thereof.

Step 100: Receive a first product selection and payment amount.

At Step 100, a customer selects a product to purchase from a vending machine in any known manner (e.g. by inputting an indication of a corresponding item dispenser identifier into an input device such as a keypad) and renders payment in any known manner (e.g., deposits currency into a bill validator or coin accepting apparatus, swipes a credit card through a card reader, enters a payment authorization code with a keypad). For example, a customer may select a unit of Coca-Cola® soda from a vending machine by depressing a key marked “A1” on a keypad and depositing $1.00 into a bill validator. The vending machine control system receives the selection and an indication of the amount of currency deposited. The amount of payment available to purchase a product (i.e., the portion of payment which has been tendered but not already used in paying for a product) may be considered a “credit balance” of the vending machine. Thus, in the example immediately above, the credit balance of the vending machine is $1.00.

Step 200: Determine whether change is due. If so, proceed to Step 300.

At Step 200, the vending machine (e.g., the vending machine control system) then determines whether change is due to the customer. In one embodiment, the vending machine control system may do so by determining a price for the selected product(s) (e.g. a retail price currently charged for the product) and comparing the price to the credit balance. If the credit balance exceeds the determined price for the selected product(s), then change is due to the customer in the amount of the difference between the credit balance and the determined price.

In one embodiment, the vending machine may determine a price for the selected product(s) by retrieving, from a database (such as the Product Database depicted below), a price from a record corresponding to an identifier associated with the selected product. Further, in an embodiment, the vending machine may determine a price for the selected product by reading the price and/or a product identifier from machine-readable indicia (e.g. a bar code) or data transmitter, such as a radio frequency identification (“RFID”) transmitter, affixed to the product selected.

An exemplary Product Database is shown in TABLE 1 below: Product Database

TABLE 1

| | | | | | | Quantity | | | | |
|---|---|---|---|---|---|---|---|---|---|---|
| | | | | | | at | | | | |
| | Row | | | | | Beginning | | | Actual | |
| Product | Position | Product | Retail | | | of Fill | Quantity | Restock | Sales | Ideal Sales |
| Name | Identifier | Category | Price | Cost | Margin | Period | Remaining | Date | Rate | Rate |
| Coca- | A1 | Beverage | $0.75 | $0.35 | $0.40 | 20 | 8 | Jun. 30, 2003 | 1.2/ | 1.3/day |
| Cola ® | | | | | | | | | day | |
| Diet | A2 | Beverage | $0.75 | $0.30 | $0.45 | 20 | 6 | Jun. 30, 2003 | 1.4/ | 1.3/day |
| Coke ® | | | | | | | | | day | |
| A&W Root | A3 | Beverage | $0.65 | $0.35 | $0.30 | 20 | 9 | Jun. 30, 2003 | 1.1/ | 1.3/day |
| Beer ® | | | | | | | | | day | |
| Doritos ® | B1 | Snack | $0.50 | $0.30 | $0.20 | 25 | 11 | Jun. 30, 2003 | 1.4/ | 1.6/day |
| | | | | | | | | | day | |
| Lay's ® | B2 | Snack | $0.75 | $0.30 | $0.45 | 25 | 7 | Jun. 30, 2003 | 1.8/ | 1.6/day |
| Potato | | | | | | | | | day | |
| Chips | | | | | | | | | | |
| Cheetos ® | B3 | Snack | $0.60 | $0.30 | $0.30 | 25 | 17 | Jun. 30, 2003 | 0.8/ | 1.6/day |
| | | | | | | | | | day | |
| Double- | C1 | Chewing | $0.35 | $0.20 | $0.15 | 40 | 18 | Jun. 30, 2003 | 2.2/ | 2.6/day |
| Mint ® | | Gum | | | | | | | day | |
| Juicy | C2 | Chewing | $0.35 | $0.20 | $0.15 | 40 | 23 | Jun. 30, 2003 | 1.7/ | 2.6/day |
| Fruit ® | | Gum | | | | | | | day | |
| Dentyne ® | C3 | Chewing | $0.40 | $0.20 | $0.20 | 40 | 36 | Jun. 30, 2003 | 1.1/ | 2.6/day |
| | | Gum | | | | | | | day | |

As the above product database illustrates that, in one embodiment, for each product at least one corresponding product category is stored, as well as a corresponding retail price, cost, margin, quantity at the beginning of the fill period, quantity remaining as of the current date/time, restock date, actual sales rate and ideal sales rate. The exemplary data in the above product database assumes that the beginning of the fill period was Jun. 15, 2003, and that the current date is Jun. 25, 2003 (i.e. 10 days into the fill period; 5 days left in the fill period). Further, the exemplary data in the above product database will be referred to below to illustrate one or more embodiments.

Step 300: Determine whether to output one or more alternate value offers. If not, proceed to Step 800. If so, proceed to Step 400.

At Step 300, the vending machine control system determines whether to output an alternate value offer. Such a determination may be based on one or more factors, such as: (1) the remaining quantity of one or more products inventoried in the machine, (2) the number of days remaining in a fill period, (3) sales and/or profitability data of one or more products, (4) the machine's coin reserves, (5) the amount due to the customer as change from a first transaction (e.g. as determined from Steps 100 and 200 above), (6) the current time, date, day of the week, and other time-based considerations, (7) a maximum number of authorized offers, (8) the identity of the customer (e.g. identified through an identifier provided on a customer loyalty/reward card), and/or (9) the acceptance rate of one or more identical or similar offers. Any combination of the above factors, and any specific values considered by any of the above factors, may be employed in the determination of whether to output an offer.

The determination of whether to output an offer, and the determination of what benefit to offer, may be made according to one or more rules. The rules may be represented in many forms. In one embodiment, the rules may be embedded in a process of the control software. Changing such rules may involve changing the control software such as by software which changes rules using, e.g. artificial intelligence and/or neural network algorithms.

In another embodiment, rules are represented by a database which stores, e.g., conditions and respective offers to be output upon determining that the corresponding condition is satisfied. An advantage of storing rules in a database is that the same software can operate on databases with different data to effectively produce different rules. Thus, the same software could be installed in multiple vending machines, but these vending machines could operate differently if the data in the respective databases were different. Changing rules in such a database may involve changing (e.g. via local controlling or remote controlling) the data stored by the database, but need not require changing the software.

Software that can be used to manipulate data in such a database would be readily discernible to one of ordinary skill in the art. For example, software may be used to create/edit conditions in the database by (i) selecting a condition (e.g., inventory level), an operator (e.g., greater than, equal to), and/or a value (e.g., 30) for comparison; and (ii) chaining together more than one comparison via Boolean operators (e.g., AND, OR, NOT). Software may be used to create/edit in the database by (i) selecting categories of offers (“Please come back [return time] and receive [product] for free), and (ii) selecting values for the parameters, if any, for such categories (e.g., the return time, the product). Values in such a database may be fixed values, or may be calculated based on other values.

Such a database can represent, among other things, the factors to be considered in determining whether to output an alternate value offer, and the factors to be considered in determining what alternate value offer to output.

An Alternate Value Offer Rules Database can be consulted at Step 300. An exemplary Alternate Value Offer Rules Database, and exemplary contents thereof, is shown in TABLE 2 below:

Alternate Value Offer Rules Database

TABLE 2

| Condition(s) | Offer |
|---|---|
| IF Inventory of a product is >30 | THEN output offer: “Come back |
| when <5 days remain in fill period; | tomorrow and receive one unit of |
| AND change due customer is | [Product Name] instead of your |
| greater than [product's cost] | [change amount] by entering 1234 |
| | on the keypad.” |
| IF quarter inventory falls below 4 | THEN output offer: “Receive $0.35 |
| coins AND change due to customer | off any snack or beverage instead of |
| is $0.25 | your $0.25 change. Just enter 5874 |
| | now!” |
| IF coin reserves falls below | THEN output offer: “Come back |
| [anticipated amount of coins | tomorrow and receive double your |
| needed for remainder of fill period] | change in credit towards any |
| | beverage! Just enter 2876 |
| | tomorrow!” |
| IF coin reserves depleted | THEN output offer: “Receive triple |
| (i.e. “coin empty” mode) | your change value in machine credit |
| | by entering 4395 OR get change |
| | from adjacent machine by entering |
| | 9387.” |
| IF a product's actual sales rate is | THEN output offer: “Receive |
| <50% of [the product's ideal sales | [Product Name] in exchange for |
| rate] | your change due! Just press 6622 |
| | now!” |

As illustrated, an Alternate Value Offer Rules Database may store one or more rules that assist the vending control system in determining whether to offer one or more alternate value offers. Although the exemplary Alternate Value Offer Rules Database above represents rules as conditions and corresponding offers, other means of representing rules and like decision making structures are readily discernible by one of ordinary skill in the art. In addition, although the exemplary Alternate Value Offer Rules Database above represents conditions as Boolean evaluations, other types of conditions are readily discernible by one of ordinary skill in the art.

Example—Inventory Considerations

The first record (i.e. the uppermost row of TABLE 2) shows a rule that considers (via its corresponding condition) (i) the quantity remaining of an item, (ii) the number of days remaining in the fill period, and (iii) the amount of change due to the customer from a first transaction. Specifically, the rule provides that an offer (specifically, an offer enabling the customer to receive a product in exchange for the change due from a first transaction) should be output if inventory of the product remains above 30 units when only 5 days or less remain in the fill period and the change amount is greater than the product's cost. In this case, following the exemplary data in the above Product Database, the vending machine control system may determine that a customer who is entitled to $0.25 change from a first transaction should be offered the opportunity to purchase a package of Dentyne® chewing gum in exchange for the $0.25 change due because more than 30 units of Dentyne® chewing gum remain in inventory, only 5 days remain in the fill period, and the amount of change due is greater than the item's cost ($0.20).

Example—Coin Reserve Considerations

The second and third records of the Alternate Value Offer Rules Database illustrate embodiments in which the determination of whether to offer one or more alternate value offers depends on coin reserve data and/or potential reduction in the coin reserves. In such embodiments, a Coin Reserve Database may be employed. An exemplary Coin Reserve Database is shown in TABLE 3 below:

Coin Reserve Database:

TABLE 3

| Coin denomination | Quantity |
|---|---|
| Nickels | 7 |
| Dimes | 4 |
| Quarters | 2 |

The second record of the above Alternate Value Offer Rules Database illustrates a rule that triggers an alternate value offer when coin reserves are depleted below a predetermined, or “fixed”, threshold. Such a threshold may be established in many manners, such as being set manually (e.g., by an operator of the vending machine) or being set by a device (e.g., a processor of the vending machine). As illustrated in that table, the rule provides that if quarter inventory falls below four coins and the change due to the customer is $0.25, the machine should output an offer that enables the customer to receive a $0.35 discount off any snack or beverage in the machine if the customer agrees to forfeit the $0.25 change due. Because, in the ongoing example, quarter inventory is currently below four coins, the offer could be provided to any customer who is entitled to receive $0.25 change from a first transaction (e.g. Steps 100 and 200, above).

The third record of the above Alternate Value Offer Rules Database illustrates a rule that triggers an alternate value offer when coin reserves are depleted below a threshold that is calculated based on various data. Such thresholds may be calculated according to any schedule desirable (e.g., periodically, substantially continuously, or as-needed upon a vending machine transaction). Such threshold may be calculated by, e.g., the vending machine control system or by another means such as, for example, the MEI CASHFLOW series 7000 coin mechanism or the currency handling apparatus of WO 98/58355, described above.

In some embodiments, as illustrated by the third record of the above Alternate Value Offer Rules Database, calculated thresholds may be based on an anticipated amount of change (e.g., the anticipated amount of change needed to provide future customers with change throughout a fill period). Such thresholds may be calculated using known methods, such as the methods described in WO 98/58355. Alternatively, the control system may calculate such thresholds by calculating an anticipated amount of change due for transactions during the remainder of a fill period. For example, the control system can determine both a projected transaction volume and an average amount of change due per transaction. For example, the control system may access a Transaction History database to determine a historic transaction volume and an average change due per transaction. An exemplary Transaction History database is shown in TABLE 4 below:

Transaction History Database:

TABLE 4

| | | Item(s) | Total | Amount | Change |
|---|---|---|---|---|---|
| Date | Time | purchased | price | tendered | dispensed |
| May 5, 2003 | 11:00 AM | A1, B3 | $1.50 | $2.00 | $0.50 |
| May 5, 2003 | 11:38 AM | A3 | $0.50 | $1.00 | $0.50 |
| May 5, 2003 | 2:14 PM | B2, B3 | $1.25 | $2.50 | $0.75 |
| May 6, 2003 | 7:43 AM | C3 | $1.00 | $1.00 | $0 |
| May 6, 2003 | 9:10 AM | C1 | $0.65 | $1.00 | $0.35 |
| May 6, 2003 | 3:05 PM | C3 | $1.00 | $1.00 | $0 |

Following the exemplary data in the above Transaction History database, it appears that the transaction volume is three transactions per day, with an average of $0.35 dispensed as change. Thus, the control system may reasonably anticipate that, assuming there are five days left in the fill period, approximately $1.75 in change will be needed to provide change to customers for the balance of the fill period (e.g. conservatively assuming that all future customers pay with dollar bills and no more coins are added to the hopper).

Based on the exemplary data in the Coin Inventory database, a coin total of $1.25 exists in the coin hopper ((7 nickels*$0.05 value)+(4 dimes*$0.10 value)+(2 quarters*$0.25 value)), which is less than enough to meet the anticipated $1.75 in change needed for the remainder of the fill period. Because, in this example, there is not sufficient working capital in the hopper, the machine would determine, as required by the third record of the Alternate Value Offer Rules Database, that customers may receive double the value of their change due in credit towards the purchase of any beverage on the following day.

It will be readily apparent to one of ordinary skill in the art that there are several other manners of determining the values discussed above. For example, an average change due per transaction can be computed from historic data by maintaining (i) a running count of transactions and (ii) the average change due, as calculated over those transactions. In other words, all historic data need not be stored in some embodiments.

By way of example, the exemplary Transaction History Database illustrated above represented six transactions and an average change due of $0.35. On the next transaction, the average change due can be updated based on the new change due in that transaction in accordance with the following equation:
new average change due=(6*$0.35+X)/7
where

X=new change due

In some embodiments, a forecast of available change may be estimated (in whole or part) based on the rate at which customers generally use particular denominations of coins to make purchases at the vending machine. Thus, in some embodiments, the vending machine (or another device) may consider the number of coins that are expected to be received by the vending machine, and that number is used in determining whether or not the vending machine will likely have sufficient coin inventory in appropriate denominations to provide all future customers in the fill period with correct change

In some embodiments, both fixed and calculated thresholds may be considered in the determination of whether one or more alternate value offers should be provided to a customer. In the case of the example illustrated by the records of the above Alternate Product Offer Database, the second and third records provide for both fixed and calculated thresholds, respectively.

Further, in some embodiments, multiple alternative thresholds may be considered and different thresholds trigger different benefits (e.g., benefits with different values). That is, a first alternate value offer may be determined based on a first amount of working capital, and a second alternate value offer may be determined based on a second amount of working capital. For example, a rule may provide that if the total value of coins is below $2.00, then it may be appropriate to provide an offer having a value in excess of the value of change due (e.g., double change value in the form of credit applicable to a purchase via the vending machine). On the other hand, if the total value of coins is even lower (e.g., zero, meaning the coin reserves have been entirely depleted), then an offer to provide an even higher value offer (e.g., triple change value in the form of credit applicable to a purchase via the vending machine) may be appropriate. Thus, according to an embodiment offers may be generated so as to be more valuable to customers when the vending machine has relatively fewer coins (e.g., the vending machine is in “coin empty” mode) rather than when the vending machine has relatively more coins (e.g., the vending machine is merely in “coin conservation” mode).

The fourth record of the above-illustrated Alternate Value Offer Rules Database illustrates an embodiment in which the determination of whether to offer an alternate value offer depends on whether or not the machine's coin inventory is depleted entirely (i.e., whether the machine is in “coin empty” mode). In the example, if the machine's coin inventory is depleted entirely, customers are offered the ability to receive either triple the value of the change due amount in credit towards an additional product or receive their change from a nearby machine, which may be programmed to provide the change amount upon presentation of an appropriate code (here, “9387”). In some embodiments, such nearby machines may communicate with the first vending machine, directly or indirectly, through a communications network, as described herein. Thus, the first machine may query one or more nearby machines to (1) determine/confirm that one or more nearby machines have sufficient working capital to provide the customer of the first machine with the change amount, and (2) transmit a code that the second machine should require from the customer before providing change. Alternatively, such nearby machines may be programmed to store one or more codes in a database so that such a communication from a first machine is not necessary.

It should be noted that in yet another embodiment, when a machine has entered a “coin empty” mode, the machine may be configured to output an offer to receive change due from a first transaction from the machine at a later time, such as after a restocking date, or after it is anticipated that the machine will receive sufficient working capital through anticipated future sales.

Example—Sales/Profitability Considerations

The fifth record of the above-illustrated Alternate Value Offer Database illustrates an embodiment in which the determination of whether to offer one or more alternate value offers depends on sales and/or profitability data of one or more products. As illustrated by the fifth record, if the actual sales rate for a product is equal to or less than 50% of the product's ideal sales rate (e.g., as indicated by the Product Database, as computed according to known methodologies), then an alternate value offer which provides the customer with the opportunity to receive the product for the change amount is appropriate.

Additional systems and methods for determining offers in exchange for an amount of change due are disclosed in Applicant's (1) co-pending U.S. Provisional Patent Application Ser. No. 60/473,815, entitled APPARATUS, SYSTEM AND METHOD FOR PROFIT MANAGED VENDING MACHINE TRANSACTIONS, and the utility application filed thereafter and claiming priority thereto, (2) co-pending U.S. patent application Ser. No. 10/095,372, entitled METHOD AND APPARATUS FOR VENDING A COMBINATION OF PRODUCTS; (3) U.S. Pat. No. 6,397,193 B1, entitled METHOD AND APPARATUS FOR VENDING A COMBINATION OF PRODUCTS; the entirety of each application/patent is incorporated by reference herein for all purposes.

Types of Offers

The alternate value offers which are determined (e.g., at Step 300) can provide customers with the ability to realize various benefits in lieu of receiving change due from the first transaction (e.g., a transaction which commenced in Steps 100 and 200). Alternate value offers may provide customers with the ability to, in lieu of receiving change due from a first transaction, receive one or more “benefits”, including (but not limited to): (i) discounts (e.g., on prices of products sold via a vending machine), (ii) credits (e.g., credits applicable to purchases at a vending machine), (iii) specific products (e.g., products dispensed via a vending machine without further compensation), (iv) the ability to select and acquire one or more products from a class of products, either at a normal price, at a discount or without further compensation (e.g. any soda; any item indicated by a flashing red Light Emitting Diode (LED)), (v) entries in games of skill or games of chance, such as entries in one or more lottery drawings, (vi) the ability to download digital content (e.g. MP3 music files, computer files, ring tones for cellular telephones) from a remote computer or elsewhere, and/or (vii) a modification of another benefit or of a right of the customer.

As an example of an entry in a game of chance, a benefit may be a conventional lottery ticket (e.g., dispensed by the vending machine, printed by the vending machine, acquired upon redeeming a voucher for a lottery ticket that the vending machine provides the customer) or a “factional lottery ticket” such as is disclosed by U.S. Pat. No. 6,267,670, incorporated herein by reference.

In an embodiment, the benefit may be for a drawing in a lottery, sweepstakes, etc., conducted or monitored by the vending machine. Thus, the vending machine might inform customers upon the conclusion of the lottery, sweepstakes, etc., of the outcome (e.g., which customer won, which numbers were winning numbers, whether the customer won). Additionally or alternatively, a web site or the like could provide the outcome of the lottery, sweepstakes, etc. In an embodiment, a benefit may include a modification to another benefit or another right of a customer. For example, a ticket might multiply (or otherwise increase) the amount of credit of a product voucher, the number of unredeemed items in a subscription to a plurality of vending machine products, the number of network access minutes (e.g., WiFi or VoIP access) allotted to a customer.

U.S. Pat. Nos. 6,298,329 and 6,876,978 to Walker et al. (both incorporated herein by reference) disclose various products and processes involving coupons and vouchers having a value that is set based on the change that is due. The products and processes disclosed in those patents may be employed, in accordance with embodiments of the present invention, to provide offers for various benefits.

Moreover, alternate value offers may provide customers with the ability to receive such benefits immediately, in the future, at certain times (e.g. at an “off peak” time, such as 7:00 PM at an office building location), and/or for a limited time (e.g., within the seven days after the offer is accepted). Other types of restrictions may be imposed on the redemption of alternate value offers in a known manner.

In an embodiment, the value of a benefit can increase over time provided the benefit is not redeemed. Thus, the benefit can essentially accumulate “interest” as it remains unredeemed. In an embodiment, an additional 10% increase per week in the value of a voucher redeemable for cash accumulates. The rate of increase may be calculated based on (1) an estimated decrease in the probability of redemption over time, (2) actual sales, and/or (3) predicted or estimated sales.

In another example, a fixed amount (e.g., $0.01) can be added each day (or week, month etc.) to an unredeemed voucher that is redeemable for credit towards a purchase. In an embodiment, the cash value (the amount of cash which may be received) upon redemption of the benefit remains constant (e.g., the original amount of change due), while any increase in value (the “accumulated interest”) may be redeemed only towards one or more product purchases. Similarly, the rate of increase may be calculated based on (1) an estimated decrease in the probability of redemption over time, (2) actual sales, and/or (3) predicted or estimated sales.

Alternate value offers may also provide customers with the ability to receive such benefits at certain locations and/or at certain machines, such as at the vending machine where the offer was provided or accepted, at another vending machine, via a computer accessing the Internet, at a kiosk, at an ATM, via a cellular telephone, etc. In an embodiment where the benefit is redeemed via a vending machine, the benefit may include (a) a product typically available for sale, and/or (b) other items not typically available for sale, such as items, vouchers, coupons, etc. provided in product rows which a customer cannot access except pursuant to a redemption of a benefit. For example, an item not typically available for sale may be located in a special product row (e.g., “A-5”), and the vending machine will not permit products in that product row to be dispensed in a conventional vending machine transaction (i.e. rendering of payment and selection of the row A-5).

In one embodiment, alternate value offers may provide customers with the ability to receive benefits at one or more machines. For example, alternate value offers may provide customers with the ability to receive benefits from the machine that issued the offer, and/or from a separate machine (e.g. a beverage vending machine located next to a snack vending machine which provided the offer). In one embodiment in which an alternate value offer enables a customer to receive a benefit from a machine other than the issuing vending machine, the other machine may (1) receive alternate value offer data (e.g. a redemption or acceptance code corresponding to an alternate value offer), directly or indirectly (e.g., through a communications network as described herein), and/or (2) store alternate value offer data (e.g., in a database for retrieval and comparison upon presentation of a purported redemption, acceptance code or other indicia of an alternate value offer). Thus, during redemption or reception of a benefit (e.g. at Step 600, below), when a customer wishes to redeem or accept at a separate machine a benefit associated with an alternate value offer, the separate machine may validate an alternate value offer by comparing data received from the customer to data received from the issuing machine and/or data stored in a memory accessible by the separate machine.

Step 400: Output one or more alternate value offers.

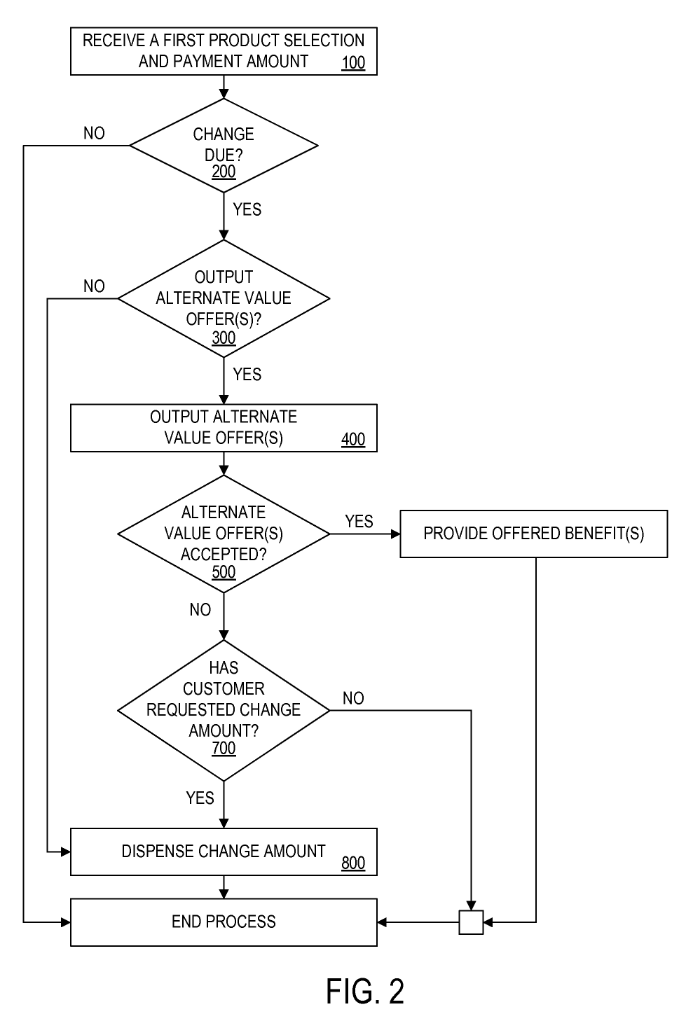

At Step 400, one or more of the determined alternate value offers may be provided to customers via an output device. For example, in one embodiment, as illustrated below, one or more alternate value offers may be provided to customers on a printed ticket. Explanatory text and an accompanying “acceptance code” may represent each alternate value offer. An example of a printed ticket providing alternate value offers is depicted in FIG. 2.

The exemplary change ticket 200 depicted in FIG. 2 illustrates indicia 210, 215, 220 and 225 representing alternate value offers and accompanying codes consistent with the ongoing example, assuming that the customer initially purchased a $0.75 item (e.g. a Coca-Cola®) soda from row position A1) for $1.00, thereby entitling the customer to $0.25 change.

A code may be provided which, when entered, allows the customer to indicate that he prefers to receive his change rather than accept any provided offer. Indicia 250 indicates such a code.

In one embodiment, unique or substantially unique acceptance codes may be generated for each alternate value offer that is output to a customer. Alternate value offer acceptance codes may thus, in one embodiment, comprise non-sequentially generated alphanumeric codes. It should also be noted that in one embodiment, a database may be maintained to track the issuance and acceptance (redemption) of particular alternate value offers so that a customer may not obtain a given benefit more than a certain number of times (e.g. so that offers are limited to one per customer or one per purchase of a first product).

Step 500: Determine whether one or more alternate value offers are accepted. If so, proceed to Step 600. If not, proceed to Step 700.

At Step 500, it is determined whether one or more alternate value offers are accepted. Such a determination may be made by the vending control system receiving a signal from an input device indicative of a customer's acceptance. For example, to indicate acceptance of a particular alternate value offer, a customer may enter a code printed on a change ticket into a vending machine's keypad. Alternatively, a customer may deposit a ticket into a bill validator or card reader, may scan a ticket's machine-readable indicia into an input device (e.g. a bar code scanner), or may verbally provide a manifestation of acceptance to an input device (e.g. a microphone operatively connected to a voice recognition module). Those of ordinary skill in the art will recognize that there are many other methods of redeeming or accepting an offer.

As stated, in some embodiments, the machine which issued the alternate value offer(s) determines whether a customer accepts the alternate value offer(s). In other embodiments, a separate vending machine determines whether a customer accepts the alternate value offer(s). In yet other embodiments, a separate computer (e.g., a point-of-sale computer or a web server) determines whether a customer accepts the alternate value offer(s).

In an embodiment, alternate value offers may expire if not accepted within a certain time from issuance at Step 400. For example, in one embodiment, alternate value offers may time out (i.e. the customer's “silence” is a rejection) if an acceptance code is not received within 5 minutes of issuance. In such embodiments, after the time period for acceptance passes, the process may optionally continue at Step 800 (at which point change due is dispensed), or may otherwise end.

Further, in yet another alternate embodiment, alternate value offers are considered accepted if not affirmatively accepted or rejected within a default period of time, in which case the process may continue at Step 600, below.

In some embodiments, acceptance of one or more alternate value offers may constitute rejection of others.

Step 600: Provide offered benefit(s).

If one or more alternate value offers have been accepted, the vending machine control system permits the customer to realize the corresponding offered benefit(s). In various embodiments, permitting the customer to realize a benefit may entail one or more of: (i) processing a transaction at a discount, (ii) adding an amount to a credit balance, (iii) dispensing a particular product, and/or (iv) authorizing the selection of a product from a category, class or group. Other appropriate benefits will be readily apparent to those of ordinary skill in the art.

In an alternate embodiment, a separate device such as a separate vending machine, a point-of-sale computer or a Web server may (i) receive an alternate value offer acceptance code, (ii) validate the received acceptance code (by determining if the received acceptance code is stored in a database or has been received from or confirmed with the issuing vending machine), and/or (iii) provide (or facilitate the provision of) a benefit (e.g. authorize a discount, etc.).

Step 700: Determine whether customer has requested change due. If not, end process. If so, proceed to Step 800.

In some embodiments, customers must affirmatively request change if they wish to reject alternate value offers and receive change. In other embodiments, change is automatically dispensed (Step 800, below) if customers do not accept alternate value offers within a default period of time.

In some embodiments where customers must affirmatively request change in order to receive change, if a customer has not requested change within a default period of time, the process ends, and the customer may subsequently claim the change amount from the machine. In other embodiments where customers must affirmatively request change in order to receive change, if a customer has not requested change within a default period time, the change is considered abandoned and forfeited to the operator of the vending machine.

Step 800: Dispense change amount.

At Step 800, the vending machine control system authorizes the dispensing of the change amount via change dispensing apparatus.

For clarification, although in some embodiments an alternate value offer may be output if change is due, in other embodiments an alternate value offer may be output even if change is not due.

For example, in one embodiment, an alternate value offer may be output after a customer has inserted an amount of currency but before the customer has selected a product to purchase.

In another embodiment, an alternate value offer may be output after the customer has selected a product to purchase but before the customer has inserted an amount of currency.

### FURTHER EMBODIMENTS

In one alternate embodiment, an alternate value offer may present a customer with the ability to donate change due to a charity. Such an amount may be transmitted to an account in a known manner.

In some embodiments, a door to a coin tray may remain locked until a customer affirmatively requests change due. Until a customer affirmatively requests change, visual and/or auditory outputs may be provided through one or more output devices indicating, for example, “change ticket dispensing now” (or the like) so that the customer is clearly informed about the inventive change ticket process disclosed herein.

In some embodiments, when coin reserves have fallen below a certain threshold, the machine may output certain denomination-specific promotions so as to encourage the accumulation of certain types of currency (e.g. coinage). For example, when a Coin Reserve Database indicates that dimes are below a certain threshold, the machine may offer a discount price on all items (e.g. $0.30 discount) for customers who tender only dimes. Vending machine may cease outputting such promotions once the vending machine has replenished coin reserves beyond the threshold amount.

In some embodiments, a customer may store the change due from multiple transactions in one “account”.
1. For example, before a change ticket is printed pursuant to a transaction, the customer may be prompted to enter the codes provided on previously issued change tickets. The vending machine control system may then, in turn, invalidate (e.g. in a database record) the codes associated with the previously issued change tickets, and may add the cash value associated with such previously issued change tickets to the change amount from the present transaction. Thus, the customer would receive one superceding change ticket with a code that permits access to the change due from several transactions. Such an embodiment would be desirable as it permits customers to aggregate change value in one convenient medium.
2. In another example, change due from several transactions may be aggregated to an account identified by a unique identifier associated with a particular customer. For example, a vending machine may maintain an account database, wherein records of the database are identified by alphanumeric codes unique to customers or by customer biometric data (e.g. fingerprints, etc.).

As stated herein, in some embodiments, customers are permitted to accept or redeem alternate value offers or receive change due from machines other than the machine that initially issued a change ticket and/or alternate value offer. In some of such embodiments, participating vending machines may be configured to record and/or report redemption data so that operators may reconcile and understand which machines facilitated the redemption of change amounts or alternate value offers. For example, one vending machine operator (e.g. a snack machine operator) may contract with another vending machine operator (e.g. a separate beverage machine operator) so that each machine accepts change ticket codes issued from either machine. Thus, if the machines are proximately located, and one machine's coin reserves are depleted, the machine may issue a change ticket so that a customer may receive change due from the second machine. When such a customer presents the change ticket code to the second machine and thereby receives her change due, the second machine may then record (e.g. in a database record) and/or report (e.g. to the first machine, to a central server, etc.) the provision of the change amount so that the operator of the first machine may subsequently reimburse the operator of the second machine for the change amount.

The offer may be provided via the vending machine (e.g., during a transaction with a customer at that vending machine). Alternatively, the offer may be provided via other means. For example, the offer may be provided through Web site, where the customer may register preferences regarding offers. In such an embodiment, one or more offers may be provided through the web site and accepted by the customer, whether or not a transaction at a vending machine is occurring, and whether or not a transaction at a vending machine has occurred.

For example, the customer may (1) access a web site, such as a web site operated by or on behalf of a vending machine operator; (2) identify himself to the web site (e.g., by entering a unique customer identifier and password); (3) indicate preferences regarding offers and/or accept certain offers.

The customer may indicate such preferences by, e.g., operating a graphical user interface via a standard Web browser, where the user interface is generated in any of a number of manners (e.g., by HTML code or the like, by active server pages, by Macromedia Flash® animation).

The preferences which the customer indicates may correspond to rules described herein (e.g., alternate value offer rules). In an embodiment, the customer is provided with a set of rules (e.g., via a Web browser) and the customer selects the rule(s) he desires to apply to vending machine transactions. For example, the customer may be provided with the following rules:

TABLE 6

| Condition(s) | Offer |
|---|---|
| ALWAYS | “Come back tomorrow and receive |
| | one unit of [Product Name] instead |
| | of your [change amount]” |
| change due to customer is $0.25 or | “Receive $0.35 off any snack or |
| less | beverage instead of your $0.25 |
| | change.” |

Subsequently, when that customer participates in transactions with the vending machine and identifies himself to the vending machine, the applicable rule is applied to the transaction. Thus, during that transaction the customer need not be presented with an offer and the customer need not during that transaction accept an offer.

What is claimed is:

1. A method comprising:
providing an offer to receive a benefit in lieu of receiving change that is due from a transaction with a vending machine.

2. The method of claim 1, in which the benefit comprises at least one of:
a discount,
an amount of credits, and
a product provided without additional payment.

3. The method of claim 1, in which the step of providing an offer comprises:
providing the offer via a vending machine.

4. The method of claim 1, in which the step of providing an offer comprises:
providing the offer via a Web site.

5. The method of claim 1, in which the benefit has a value that is greater than a value of the change that is due.

6. A method comprising:
determining that change is due from a transaction with a vending machine;
outputting at least a first code and a second code, in which
the first code is associated with a command to dispense currency in an amount equal to the change due, and
the second code is associated with a command to issue credit redeemable for at least one item that is dispensed by vending machine.

7. The method of claim 6, further comprising:
determining that an amount of coins in a coin reserve is less than a predetermined threshold.

8. The method of claim 6, in which
the second code is associated with a command to increase a credit balance of the vending machine.

9. A method comprising:
receiving a selection of a product that is available for dispensing by a vending machine;
receiving an amount of payment;
determining that change is due based on the selection and the amount of payment;
determining whether to output an offer for a benefit in lieu of receiving change that is due;
outputting an offer for a benefit in lieu of receiving change that is due;
receiving an acceptance of the offer; and
providing the benefit.

10. The method of claim 9, in which determining whether to output an offer for a benefit in lieu of receiving change that is due comprises:
determining whether to output an offer for a benefit in lieu of receiving change that is due based on at least one of
a remaining quantity of a product,
a number of days remaining in a fill period,
sales data of a product,
a coin reserve,
an amount of change that is due
a current time
a maximum number of authorized offers,
an identity of a customer,
an acceptance rate of an offer.

11. The method of claim 9, in which the benefit comprises at least one of:
a discount,
an amount of credits, and
a product provided without additional payment.

12. The method of claim 9, in which the step of outputting an offer comprises:
outputting the offer via a vending machine.

13. The method of claim 9, in which the benefit has a value that is greater than a value of the change that is due.

14. The method of claim 9, further comprising:
determining the value of the change that is due; and
selecting the benefit based on the value of the change that is due.
